(19) United States
(12) Patent Application Publication
(10) Pub. No.: US 2026/0168854 A1
(43) Pub. Date: Jun. 18, 2026

(54) A SPECTROMETER DEVICE AND A METHOD FOR A CLASSIFICATION OF A SAMPLE

(71) Applicant: TRINAMIX GMBH, Ludwigshafen am Rhein (DE)

(72) Inventors: Sourabh KULKARNI, Mannheim (DE); Christoph PROKOP, Ludwigshafen am Rhein (DE); Celal Mohan OEGUEN, Ludwigshafen am Rhein (DE)

(21) Appl. No.: 19/126,352

(22) PCT Filed: Nov. 14, 2023
(86) PCT No.: PCT/EP2023/081685

§ 371 Date: May 1, 2025

(30) Foreign Application Priority Data
Nov. 15, 2022 (EP) 22207568.1

(51) Int. Cl. G01J 3/42; G01J 3/02; G01J 3/10; G01J 3/28; G01N 21/35

(52) U.S. Cl. CPC G01J 3/42; G01J 3/021; G01J 3/0291; G01J 3/10; G01J 3/28; G01N 21/35

(57) ABSTRACT

Disclosed herein is a spectrometer device for a classification of a sample including at least one evaluation device, where the at least one evaluation device is configured for performing a physical classification of the sample and a chemical classification of the sample by considering a first detector module signal and a second detector module signal.

Further disclosed herein are a method for a classification of a sample, a computer program, and a non-transient computer-readable storage medium.

The spectrometer device for a classification of a sample, the method for a classification of a sample, the computer program and the non-transient computer-readable storage medium provide a compact spectrometer device that may be capable of a reliable, easy, versatile and fast classification of a sample.

### FIELD OF THE INVENTION

The present invention refers to a spectrometer device for a classification of a sample, a method for a classification of a sample, a computer program and a non-transient computer-readable storage medium. Such a spectrometer device may, in general, be employed for investigation or monitoring purposes, specifically for a classification purpose.

### PRIOR ART

Plastic recycling has become a very relevant topic due to the enormous amount of waste generated from plastics. To cope with this waste, plastic sorting that is time and cost efficient has become increasingly important.

Using spectrometers, specifically using near infrared wavelengths of larger than 800 nm, for the identification and/or classification of material properties, particularly as required for plastic sorting, may be considered, typically, as a common practice. However, depending on a considered wavelength some of the materials to be classified are opaque or very less transparent. In example HDPE may typically show larger reflectivity at 1300 nm than PETE. For this wavelength HDPE may be considered as the less transparent material. For the sorting of these materials, in general a primary sorting, which is typically visual inspection may be required before a classification can be performed. Generally, the classification may be based on the chemical property of a sample that may be determined by using a transmission and/or a reflection based spectroscopy. The drawback of such systems is, that systems having an automated visual inspection are generally complicated and bulky due to the required additional visual sensor, which may be, typically, a high resolution CCD camera.

Various kinds of devices and methods for material classification that employ NIR spectroscopy may be known. These devices and methods may be, typically, based on an application of techniques for the analysis of a spectrum, which may be generated by a spectrometer device. Herein, the spectrometer device may be used in a reflection configuration or a transmission configuration, depending on the particular application. In an application involving an opaque material, such as a piece of textile, a spectrometer device having a reflection configuration may be, generally, used. In a further application direct to the classification of a transparent material, in particular a glass or a plastic material, such as PET, PP, PE, a transmission configuration may be, generally, used. In a still further application which involves both the reflection configuration and the transmission configuration, a sequential classification may be, typically, employed.

WO 2015/121070 A1 relates to a device, system and method for determining vital signs of a subject. To improve accuracy and reliability, the device comprising a detection unit for contactless detection of light in at least two different wavelength ranges from a region of interest of a subject, wherein said detection unit is configured to detect a first light portion in a first wavelength range from light reflected from said region of interest in response to illumination by a first light source and to detect a second light portion in a second wavelength range from light transmitted through said region interest in response to illumination by a second light source, wherein said detection unit is configured to detect said first light portion and said second light portion simultaneously in response to illuminations that are at least temporarily simultaneous and wherein said first wavelength range and said second wavelength range are different. A processing unit is provided for deriving plethysmography, PPG, signals from the detected light for said at least two different wavelength ranges. An analysis unit is provided for deriving a desired vital sign from the PPG signals for at least two different wavelength ranges.

US 2017/0202493 A1 relates to a device and method for noninvasively determining the hematocrit value of a subject. The device comprises a light source for emitting light onto a skin area of the subject, said light comprising first light at a first wavelength in a first wavelength range between 500 and 1000 nm and second light at a second wavelength in a second wavelength range between 1000 and 2000 nm, a reflection detector for detecting light reflected from said skin area of the subject in response to light illumination by said light source, a transmission detector for detecting light transmitted through said skin area of the subject in response to light illumination by said light source, a processing unit for deriving plethysmography, PPG, signals for said first and second wavelengths from the light detected by said reflection detector and said transmission detector, and an analysis unit for determining the hematocrit value of the subject from said PPG signals.

GB 2604346 A discloses a method for measuring analyte concentration, e.g. within blood in vivo, that comprises using an optical source to illuminate biological material with optical radiation of wave-length between 400 nanometers and 25 micrometers and a radio-frequency (RF) radiation source to irradiate with a wavelength between 1 millimeter and 30 centimeters. Optical detector and RF detector detect signals from the biological material. A concentration of glucose in the biological material is determined based on both signals detected. This may be done sequentially or simultaneously, with the detectors placed on either the same or opposite side of the biological material as the emitters, e.g. at either side of the skin between the finger and thumb, positioned e.g. by a wearable strap holder placed around the web of the hand. Detecting signals at both infrared and RF may increase sensitivity and specificity.

### PROBLEM TO BE SOLVED

It is therefore desirable to provide a spectrometer device, a method for a classification of a sample, a computer program and a non-transient computer-readable storage medium, which at least partially overcome the problems of the state of the art. It is further desirable to provide a compact spectrometer device that is capable of a reliable, easy, versatile and fast classification of a sample.

### SUMMARY OF THE INVENTION

This problem is solved by a spectrometer device, a method for a classification of a sample, a computer program and a non-transient computer-readable storage medium having the features of the independent claims. Advantageous embodiments which can be implemented in isolated fashion or in arbitrary combination are listed in the dependent claims and through the description.

In a first aspect of the present invention, a spectrometer device for a classification of a sample is disclosed. The spectrometer device is comprising
at least one radiation source, wherein the at least one radiation source is configured for emitting radiation;
at least one sample holder, wherein the at least one sample holder is configured for holding a sample;
at least one detector module,
   wherein the at least one detector module is arranged in a manner to detect at least a portion of the emitted radiation that is reflected by the sample such that a first detector module signal is generated;
   wherein the at least one detector module is further arranged in a manner to detect at least a portion of the emitted radiation that is transmitted through the sample such that a second detector module signal is generated;
at least one evaluation device, wherein the at least one evaluation device is configured for performing a physical classification of the sample and a chemical classification of the sample by considering the first detector module signal and the second detector module signal.

The term “spectrometer device” as used herein is a broad term and is to be given its ordinary and customary meaning to a person of ordinary skill in the art and is not to be limited to a special or customized meaning. The term specifically may refer, without limitation, to an apparatus which is capable of classifying a sample, particularly be considering at least one integrated detector module signal and/or at least one wavelength resolved detector module signal. Thereby, a signal intensity may be recorded, particularly with respect to a corresponding wavelength of a spectrum or a partition thereof, such as a wavelength interval. The term “spectrum” as used herein is a broad term and is to be given its ordinary and customary meaning to a person of ordinary skill in the art and is not to be limited to a special or customized meaning. The term specifically may refer, without limitation, to a partition of an optical spectral range, particularly of the incident radiation. Each partition of the spectrum may be constituted by a detector signal, which may be defined by a signal wavelength and the corresponding signal intensity.

The term “classification” as used herein is a broad term and is to be given its ordinary and customary meaning to a person of ordinary skill in the art and is not to be limited to a special or customized meaning. The term specifically may refer, without limitation, to a process of grouping a plurality of objects, particularly a plurality of samples, into at least two different classes. The classes may together form a classification. The sorting may be performed by applying at least one sorting criteria. Thereby, a first object may show a first criteria, such as a first criteria relevant for the sorting process, and may as a result be sorted into a first class, while a second object may show a second criteria, such as a second criteria relevant for the sorting process, and may as a result be sorted into a second class that may be different from the first class, particularly because the first shown criteria may be different from the second shown criteria. In terms of the present invention, the classification may be performed by applying a physical criteria such as in a physical classification. Additionally or alternatively, the classification may be performed by applying a chemical criteria, such as in a chemical classification.

The term “radiation” as used herein is a broad term and is to be given its ordinary and customary meaning to a person of ordinary skill in the art and is not to be limited to a special or customized meaning. The term specifically may refer, without limitation, to waves and/or particles that carry energy. The radiation may be electromagnetic radiation. Electromagnetic radiation may be formed by at least one electromagnetic field wave. The electromagnetic radiation may be selected from at least one of: radio waves; microwaves; infrared; visible light; ultraviolet; X-rays; or gamma rays. In terms of the present invention, particularly electromagnetic radiation, such as infra-red radiation, specifically having a wavelength of 780 nm to 15 μm, preferably of 1 μm to 5 μm, more preferred of 1 μm to 3 μm, in particular of 2 μm to 3 μm may be particularly advantageous.

The term “radiation source” as used herein is a broad term and is to be given its ordinary and customary meaning to a person of ordinary skill in the art and is not to be limited to a special or customized meaning. The term specifically may refer, without limitation, to a unit, an entity or a device that generates radiation, particularly such as, but not limited to, radiation as defined above, specifically electromagnetic radiation. The radiation source may be configured for exposing the sample with at least a portion of the radiation. Thereby, the at least a portion of the generated radiation may be generated in a manner that it may be incident on the sample, particularly when the sample may be arranged, specifically as intendent, in the sample holder. The radiation that may be generated may be propagating, particularly due to a respective guiding in the spectrometer device, to the sample arranged, particularly as intended, in the sample holder.

A typical radiation source may be a thermal radiator, particularly a blackbody and/or an incandescent lamp, and/or a MEMS-based emitters. The term “thermal radiator” as used herein is a broad term and is to be given its ordinary and customary meaning to a person of ordinary skill in the art and is not to be limited to a special or customized meaning. The term specifically may refer, without limitation, to a radiation source from which radiation is emitted by heating of a material. The term “incandescent lamp” as used herein is a broad term and is to be given its ordinary and customary meaning to a person of ordinary skill in the art and is not to be limited to a special or customized meaning. The term specifically may refer, without limitation, to a source of radiation, particularly electromagnetic radiation, comprising a heatable element, such as a wire filament, which may be capable of being heated to a temperature at which it emits radiation, particularly electromagnetic radiation, specifically infrared radiation. Since the incandescent lamp may, therefore, be considered as a thermal emitter within the infrared spectral range, an emission power of the incandescent lamp decreases with increasing wavelength. The term “blackbody” as used herein is a broad term and is to be given its ordinary and customary meaning to a person of ordinary skill in the art and is not to be limited to a special or customized meaning. The term specifically may refer, without limitation, to a physical body that absorbs and/or emits all incident electromagnetic radiation, regardless of frequency, wavelength or angle of incidence. The spectrum of light emitted by a heated object may be considered as a black body spectrum. The spectral intensity of blackbody radiation may peak at a frequency that increases with the temperature of the emitting body. The term “MEMS-based emitters” as used herein is a broad term and is to be given its ordinary and customary meaning to a person of ordinary skill in the art and is not to be limited to a special or customized meaning. The term specifically may refer, without limitation, to a microelectromechanical based emitter.

Alternatively a typical radiation source may be a semiconductor-based radiation source, particularly selected from a light emitting diode, LED, and/or a laser, such as a laser diode; a VCSEL; a quantum-well/dots; a plasma radiation sources, such as a low/high pressures source, or a Xenon source; a gas laser; or a solid state laser. The term “semiconductor-based radiation source” as used herein is a broad term and is to be given its ordinary and customary meaning to a person of ordinary skill in the art and is not to be limited to a special or customized meaning. The term specifically may refer, without limitation, to a radiation source from which radiation is emitted by using a semiconductor. The term “a light emitting diode” as used herein is a broad term and is to be given its ordinary and customary meaning to a person of ordinary skill in the art and is not to be limited to a special or customized meaning. The term specifically may refer, without limitation, to a semiconductor device that emits light when electric current flows in the forward direction. In the opposite direction, the LED may block the electric current. A wavelength of the emitted light may depend on a semiconductor material and/or a doping of a diode comprised by the LED. The term “laser” as used herein is a broad term and is to be given its ordinary and customary meaning to a person of ordinary skill in the art and is not to be limited to a special or customized meaning. The term specifically may refer, without limitation, to a device used for generating laser beams, particularly of coherent light. A laser may make use of the effect that electromagnetic radiation may be generated and/or amplified by stimulated emission of radiation. A laser may typically comprise an active medium, a pump and a resonator.

The term “sample” as used herein is a broad term and is to be given its ordinary and customary meaning to a person of ordinary skill in the art and is not to be limited to a special or customized meaning. The term specifically may refer, without limitation, to an arbitrary body that may be a living object and/or a non-living object. A typical sample that may be of interest for the present invention may be a polymer sample, comprising a polymer material. It may be still emphasized that the present invention may not be limited to polymer samples, but rather affects any kind of sample having any kind of material. Exemplarily, a sample may be of a pharmaceutical material; and/or an organic material, particularly comprised by food, beverage, or a skin, specifically a skin of a human.

A sample may reflect and/or transmit and/or absorb radiation that is incident on the sample with a particular intensity dependent on the chemical composition of the sample and/or the material of the sample. A wavelength unresolved intensity, such as provided by considering an integrated detector module signal of the at least one detector module, particularly a first detector and/or a second detector module, of the detected reflected radiation and/or the detected transmitted radiation may be evaluated, particularly for performing the physical classification.

In addition, the sample may further absorb at least a part of the incident radiation dependent on the chemical composition of the sample and/or the material of the sample. Thus a spectrum of the sample may be evaluated, particularly during the chemical classification, particularly for determining the composition of the material of the sample. The spectrum may be provided by considering a wavelength resolved detector module signal of the at least one detector module, specifically the first detector module and/or the second detector module.

Any sample may be placed, particularly as intended, in the sample holder. The sample holder may, thus, be configured for arranging the sample in manner that radiation generated by the at least one radiation source is incident on the at least one sample, particularly such that the incident radiation may be reflected and/or transmitted. The radiation that is reflected and/or transmitted may be propagating, particularly due to a respective guiding in the spectrometer device, to the respective detector module for detecting the respective radiation.

The term “detector module” as used herein is a broad term and is to be given its ordinary and customary meaning to a person of ordinary skill in the art and is not to be limited to a special or customized meaning. The term specifically may refer, without limitation, to an arrangement of one sensor or detector or at least one sensor or detector or a plurality of sensors or detectors for detecting radiation. The detected radiation may be generated by the at least one radiation source and may be reflected and/or transmitted by the sample.

The at least one detected radiation may generate at least one detector module signal. The detector module signal may be evaluated, particularly by using the evaluation device, for considering an integrated detector module signal, such as detector module signal that is generated by any detected radiation, particularly incident on the detector module. The integrated detector module signal may comprise one piece of information, which may be the total intensity of any radiation detected by the respective detector module. In case the detector module may comprise a plurality of detectors, particularly wherein at least two detectors of the plurality of detectors detect different wavelengths, the integrated detector module signal may be the sum of the signals generated by at least two detectors or each detector of the plurality of the detectors.

Alternatively or in addition, the detector module signal may further be evaluated, particularly by using the evaluation device, for considering a wavelength resolved detector module signal, particularly in a manner that a spectrum of the sample may be recorded and/or determined, particularly for an evaluation in the chemical classification. The wavelength resolved detector module signal may comprise at least two pieces of information, particularly a first information of an intensity of radiation comprised by a first wavelength interval and second information of an intensity of radiation comprised by a second wavelength interval that is different from the first wavelength information. In case the detector module may comprise a plurality of detectors, particularly wherein at least two detectors of the plurality of detectors detect different wavelengths, a first detector may generate the first information and a second detector may generate the second information. For generating the spectrum at least one optical filter may be used.

Typically a detector comprised by the at least one detector module, particularly the first detector module and/or the second detector module, may comprise at least one detector having a photoconductive material selected from at least one of lead sulfide (PbS), lead selenide (PbSe), germanium (Ge), indium gallium arsenide (InGaAs, including but not limited to ext. InGaAs), indium antimonide (InSb), or mercury cadmium telluride (HgCdTe or MCT). The term “photoconductive” as used herein is a broad term and is to be given its ordinary and customary meaning to a person of ordinary skill in the art and is not to be limited to a special or customized meaning. The term specifically may refer, without limitation, to an optical and/or electrical property of a material that causes the material to increase its electrical conductivity due to the absorption of radiation, particularly electromagnetic radiation.

The term “is arranged in a manner to detect at least a portion of the emitted radiation that is reflected by the sample” as used herein is a broad term and is to be given its ordinary and customary meaning to a person of ordinary skill in the art and is not to be limited to a special or customized meaning. The term specifically may refer, without limitation, to a positioning of the at least one detector module in a manner that the radiation that is generated by the radiation source and that is further reflected by the sample is incident, particularly due to a respective guiding, on the at least one detector module. The term “reflecting” or any grammatical variation thereof, particularly including “reflected” refers to a bounce back of at least one wave, particularly a radiation wave, at an interface where the characteristic impedance or refractive index of the propagation medium changes. A sample may not necessarily reflect radiation, therefore the first detector module signal may indicate and/or comprise information that no radiation is reflected.

The term “is arranged in a manner to detect at least a portion of the emitted radiation that is transmitted by the sample” as used herein is a broad term and is to be given its ordinary and customary meaning to a person of ordinary skill in the art and is not to be limited to a special or customized meaning. The term specifically may refer, without limitation, to a positioning of the at least one detector module in a manner that the radiation that is generated by the radiation source and transmitted by the sample, particularly by propagating through the sample, is incident, particularly due to a respective guiding, on the detector module. The term “transmitting” or any grammatical variation thereof, particularly including “transmitted” refers to a quantity for the permeability of a medium for waves, e.g. for electromagnetic waves. A sample may not necessarily transmit radiation, therefore the second detector module signal may indicate and/or comprise information that no radiation is transmitted.

The term “detector module signal” as used herein is a broad term and is to be given its ordinary and customary meaning to a person of ordinary skill in the art and is not to be limited to a special or customized meaning. The term specifically may refer, without limitation, to a signal that is generated by a respective detector module. As discussed elsewhere herein, the detector module signal may be evaluated, particularly by using the evaluation device, for considering an integrated detector module signal, such as detector module signal that is generated by any detected radiation, particularly incident on the detector module. Alternatively or in addition, the detector module signal may be further evaluated, particularly by using the evaluation device, for considering a wavelength resolved detector module signal, particularly in a manner that a spectrum of the incident radiation, particularly a spectrum of the sample in the sample holder may be determined.

The terms “first”, “second”, “third” and so on as used herein is a broad term and is to be given its ordinary and customary meaning to a person of ordinary skill in the art and is not to be limited to a special or customized meaning. The term specifically may refer, without limitation, to a description of an element without specifying an order or a chronological sequence and without excluding a possibility that other elements of the same may be present. A “first” element may be different from a “second” element and a “third” element. A “second” element may be different from a “first” element and a “third” element. A “third” element may be different from a “first” element and a “second” element.

The term “evaluation device” as used herein is a broad term and is to be given its ordinary and customary meaning to a person of ordinary skill in the art and is not to be limited to a special or customized meaning. The term specifically may refer, without limitation, to an arbitrary functional element configured for analyzing and/or processing data. The evaluation device may specifically analyze and/or process measurement data, e.g. the first detector module signal and the second detector module signal. The evaluation device may in particular comprise at least one processor. The processor may specifically be configured, such as by software programming, for performing one or more evaluation operations on the measurement results, such as a physical classification and/or a chemical classification. The evaluation device may be connect to the at least one detector module, specifically the first detector module and/or the second detector module, via a signal connection, specifically a wire, for transmitting at least one electronic signal and/or at least one optical signal, particularly the respective detector module signal.

The term “physical classification” as used herein is a broad term and is to be given its ordinary and customary meaning to a person of ordinary skill in the art and is not to be limited to a special or customized meaning. The term specifically may refer, without limitation, to a sorting of a plurality of objects on the basis of at least one physical property. A physical classification may be performed on basis of a physical optical property, such as a physical optical property that is determined by evaluating the at least one integrated detector module signal of the at least one detector module. For performing the physical classification, the fraction of radiation, particularly generated by the radiation source, that is reflected by the sample and/or that is transmitted by the sample may be determined.

The term “chemical classification” as used herein is a broad term and is to be given its ordinary and customary meaning to a person of ordinary skill in the art and is not to be limited to a special or customized meaning. The term specifically may refer, without limitation, to a sorting of a plurality of objects on the basis of at least one chemical property. In such a classification the object may be classified by at least one element and/or a compound or mixture of a plurality of elements, particularly by evaluating the spectrum of the sample. A chemical classification may be performed on basis of an evaluation of at least one wavelength resolved detector module signal of the at least one detector module.

The term “considering the first detector module signal and the second detector module signal” as used herein is a broad term and is to be given its ordinary and customary meaning to a person of ordinary skill in the art and is not to be limited to a special or customized meaning. The term specifically may refer, without limitation, to an analysis of the first detector module signal and/or the second detector module signal. Thereby, both detector module signals may be compared to each other, particularly as part of the physical classification. The first detector module signal or the second detector module may further be considered or analyzed for determining the spectrum generated by the sample, particularly as part of the chemical classification. In the chemical classification the wavelength resolved detector module signal of the first detector module signal or the second detector module signal having a larger intensity may be considered. As a sample may reflect and/or transmit the incident radiation fully, the detector module signal may indicate that no radiation is transmitted and/or reflected by the sample. Exemplarily, the respective at least one integrated detector module signal may be zero.

For further details concerning the spectrometer device for a classification of a sample, a reference may be made to any aspect or definition according to the present invention as disclosed elsewhere herein.

The physical classification may further be based on an integrated detector module signal provided by considering the first detector module signal; and/or the second detector module signal, wherein the integrated detector module signal is configured for determining an intensity of radiation incident on the at least one detector module. The term “integrated detector module signal” as used herein is a broad term and is to be given its ordinary and customary meaning to a person of ordinary skill in the art and is not to be limited to a special or customized meaning. The term specifically may refer, without limitation, to an evaluation of the respective detector module signal for considering, specifically any, detected radiation that is incident on the respective detector module. A radiation may be detected, as long as the detector module and/or at least one detector comprised by the detector module is sensitive to the wavelength of the radiation. Thereby, radiation of any wavelength or frequency that is detected by the respective detector module may be considered by and/or contribute to the integrated detector module signal. Alternatively or in addition, at least two or each detector comprised by the detector module may contribute to the integrated detector module signal. The integrated detector module signal may be the sum of at least two detector signals or any detector signal, generated by at least two detectors or any detector, respectively, comprised by the detector module.

The first detector module signal and the second detector module signal may be considered for performing the physical classification by at least one of:
determining a ratio between the first detector module signal and the second detector module signal, or vice versa; or
determining a difference between the first detector module signal and the second detector module signal, or vice versa.

The first detector module signal may be proportional to at least a portion of the radiation that is generated by the at least one radiation source and that is reflected by the sample onto the at least one detector module. Thereby, the first detector module signal may be proportional to the intensity of the reflected radiation. The second detector module signal may be proportional to at least a portion of the radiation that is generated by at the least one radiation source and that is reflected by the sample onto the at least one detector module. Thereby the second detector module signal may be proportional to the intensity of the transmitted radiation. For determining a “ratio” of the first detector module signal and the second detector module signal, or vice versa, may be divided. From the quotient determined by dividing both detector module signals, the fraction of radiation, particularly generated by the radiation source, that is reflected and that is transmitted may be determined. For determining a “difference” of the first detector module signal and the second detector module signal, or vice versa, both detector module signals may be subtracted.

The sample may be classified by the physical classification by at least one of:
a reflection value related to the sample; or
a transmission value related to the sample.

The term “reflection value” as used herein is a broad term and is to be given its ordinary and customary meaning to a person of ordinary skill in the art and is not to be limited to a special or customized meaning. The term specifically may refer, without limitation, to a measured of a degree of a reflection of an object, particularly the sample. The reflection value may be used for physically classifying the sample. Thereby, a plurality of samples may be sorted in different classes by considering the reflection value as a sorting criteria. A sample may be assigned to a specific class due to a reflection value of the sample being within an accepted range of reflection values of the specific class. Exemplarily, a sample may be assigned to a first class as the sample has a reflection value within a first range. A different sample may be assigned to a second class as the sample has a reflection value within a second range.

The term “transmission value” as used herein is a broad term and is to be given its ordinary and customary meaning to a person of ordinary skill in the art and is not to be limited to a special or customized meaning. The term specifically may refer, without limitation, to a measured of the degree of transmission or transparency of an object, particularly the sample. The transmission value may be used for physically classifying the sample. Thereby, a plurality of samples may be sorted in different classes by considering the transmission value as a sorting criteria. A sample may be assigned to a specific class due to a transmission value of the sample being within an accepted range of transmission values of the specific class. Exemplarily, a sample may be assigned to a first class as the sample has a transmission value within a first range. A different sample may be assigned to a second class as the sample has a transmission value within a second range. The reflection value and the transmission value may both be considered for classifying the sample.

The transmission value and the reflection value may both be considered in the physical classification. This combination may be considered as transflexion.

The chemical classification may be based on at least one wavelength resolved detector module signal provided by considering the first detector module signal; and/or the second detector module signal, wherein the wavelength resolved detector module signal is configured for determining a spectrum of the sample. The term “wavelength resolved detector module signal” as used herein is a broad term and is to be given its ordinary and customary meaning to a person of ordinary skill in the art and is not to be limited to a special or customized meaning. The term specifically may refer, without limitation, to an evaluation of the respective detector module signal for considering a spectrum of the detected radiation that is incident on the detector module, such that exemplarily a spectrum of the sample may be determined by evaluating a respective wavelength resolved detector module signal. As already discussed above, a radiation may be a detectable radiation, as long as the detector module and/or at least one detector comprised by the detector module is sensitive to the wavelength of the radiation. The wavelength resolved detector module signal may comprise information about at least two different intensities related to at least two different wavelengths and/or at least two different wavelength intervals.

The at least one detector module, particularly the first detector module and/or the second detector module, may comprise at least a first detector generating a first detector signal and a second detector generating a second detector signal, wherein the first detector and the second detector may detect at least one intensity of at least one different wavelength. By using a plurality of detectors for the detector module, the spectrum of sample may be recorded. The first detector module may generate the first piece of information of an intensity for a first specific wavelength range. The second detector module may generate the second piece of information of an intensity for a second specific wavelength range. A detector module may comprise further detectors. For generating the spectrum of the sample an optical filter may be used.

The first detector signal and the second detector signal of the first detector module may be considered for performing the chemical classification of the sample by at least one of:
determining at least a portion of a spectrum;
considering at least one chemometric technique.

The term “at least a portion of a spectrum” as used herein is a broad term and is to be given its ordinary and customary meaning to a person of ordinary skill in the art and is not to be limited to a special or customized meaning. The term specifically may refer, without limitation, to a range of a spectrum that is, particularly detectable by the detector module as the detector module is sensitive to the wavelength of the incident. The term “chemometric” as used herein is a broad term and is to be given its ordinary and customary meaning to a person of ordinary skill in the art and is not to be limited to a special or customized meaning. The term specifically may refer, without limitation, to a chemical discipline particularly using at least one mathematical and/or statistical method to employ logic to design and/or select optimal measurement procedures and/or experiments, specifically for providing chemical information by analyzing chemical data. A classical algorithm, specifically a supervised algorithm or an unsupervised algorithm, or a regression algorithm, specifically a linear algorithm or a nonlinear algorithm, may be considered as a chemometric technique.

The chemometric technique, particularly a respective algorithm, may be implemented into a machine learning model. The term “machine learning model” as used herein is a broad term and is to be given its ordinary and customary meaning to a person of ordinary skill in the art and is not to be limited to a special or customized meaning. The term specifically may refer, without limitation, to a trainable computer-implemented architecture, particularly a trainable statistical model, that applies artificial intelligence to automatically determine a representative result, particularly the confidence value. For such a purpose the machine learning model may have to be trained. The term “training”, or any grammatical variation thereof, particularly “trained”, as used herein is a broad term and is to be given its ordinary and customary meaning to a person of ordinary skill in the art and is not to be limited to a special or customized meaning. The term specifically may refer, without limitation, to a process of determining adjustable parameters of the machine learning model using a training data for generating a trained machine learning model. The training may comprise at least one optimization or tuning process, wherein a best parameter combination is determined. The training may be carried out to improve the capability of the machine learning model to determine the representative result, particularly by analyzing training data. The training data may comprise a spectrum and a known chemical information.

The at least one evaluation device may be configured to determine a chemical property of the sample for performing the chemical classification of the sample, particularly wherein the chemical property of the sample is a chemical composition of the sample.

The term “chemical composition” as used herein is a broad term and is to be given its ordinary and customary meaning to a person of ordinary skill in the art and is not to be limited to a special or customized meaning. The term specifically may refer, without limitation, to an arrangement, a type, and/or a ratio of at least one atom and/or at least one molecule comprised by a chemical substance, specifically the sample. A chemical composition may typically vary when at least one atom and/or molecule is added and/or subtracted from the chemical substance, specifically the sample, particularly when a ratio of at least two chemical substances is modified and/or changes. In terms of the present invention, the chemical composition may be evaluated for determining the material of the sample, particularly for chemically classifying the sample, specifically by considering the chemical composition of the sample and/or the material of the sample as a sorting criteria.

The evaluation device is configured to combine
an evaluated physical classification of the sample and
an evaluated chemical classification of the sample,
   for ruling out ambiguities in the evaluated physical classification by considering the evaluated chemical classification; or vice versa. The term “combine” as used herein is a broad term and is to be given its ordinary and customary meaning to a person of ordinary skill in the art and is not to be limited to a special or customized meaning. The term specifically may refer, without limitation, to a process of connecting at least two instances by applying logic in a manner that at least one connection between the two instances is made. The physical classification of the sample may be performed in a first step of the overall classification of the sample. The chemical classification of the sample may be performed in a second step of the overall classification of the sample. The first step and the second step may be performed subsequently in the given order, in a different order, particularly such that the second step is performed before the first step, or at the same time. In an overall classification, that considers the physical classification and the chemical classification, the chemical composition or the material of the sample may be determined and/or classified. The evaluated physical classification may, particularly, allow for a narrowing of the options of possible chemical compositions or possible materials of the sample. The narrowed or remaining options may then be analyzed in the chemical classification in a manner that the chemical composition or the material of the sample is determined, particularly below a certain degree of confidence. The evaluated chemical classification may, thus, be used for determining the final chemical composition of the sample. Thereby, ambiguities concerning the chemical composition of the sample or the material of the sample may be ruled out, particularly by considering the physical classification.

At least one of:
the first detector module signal; or
the second detector module signal;
   may be configured for detecting only at least one selected features in a spectrum provided by the sample in the chemical classification that are required for ruling out ambiguities in the evaluated physical classification. The term “selected features in a spectrum” as used herein is a broad term and is to be given its ordinary and customary meaning to a person of ordinary skill in the art and is not to be limited to a special or customized meaning. The term specifically may refer, without limitation, to a predetermined property of the spectrum that is generated by a specific sample. The detector module may be configured for detecting only the at least one wavelength range that is assigned to the at least one selected feature, specifically by detecting only the wavelength ranges that are covered be the at least one selected feature. Therefore, the at least one detector module, specifically the first detector module and/or the second detector module, may be setup up, particularly by providing only the respective detectors, for detecting at least one wavelength that is required for detecting the at least one selected feature.

The respective detector module may comprise at least one first detector that is, particularly only, sensitive in a first wavelength range that is covered by at least one first feature. The respective detector module may further comprise at least one second detector that is, particularly only, sensitive in a second wavelength range that is covered by at least one second feature. The respective detector module may even further comprise at least one further detector that is, particularly only, sensitive in a further wavelength range that is covered by at least one further feature. The first wavelength range, the second wavelength rand and the further wavelength range may be different. The respective detector module may not comprise any further detector. Alternatively or in addition, the at least one radiation source may be configured for emitting only radiation required for detecting the at least one selected features in a spectrum provided by the sample in the chemical classification that is used for ruling out ambiguities in the evaluated physical classification.

The at least one detector module may comprise a first detector module and a second detector module, wherein the first detector module may be configured for generating the first detector module signal, wherein the second detector module may be configured for generating the second detector module signal.

The first detector module and the second detector module may be configured for detecting an identical wavelength range, particularly by
arranging a first optical filter in a manner that the reflected radiation is propagating through the optical filter onto the at least one first detector module; and
arranging a second optical filter in a manner that the transmitted radiation is propagating through the optical filter onto the at least one second detector module;
   wherein the first optical filter and the second optical filter are identical. The term “optical filter” as used herein is a broad term and is to be given its ordinary and customary meaning to a person of ordinary skill in the art and is not to be limited to a special or customized meaning. The term specifically may refer, without limitation, to a filter that modifies and/or selects the radiation depending on at least one criterion, specifically a wavelength, a polarization state and/or a direction of incidence radiation. The optical filter may generate a spectrum of the radiation that is incident on the optical filter, particularly by separating the incident radiation into at least two different wavelength signals. The at least two different wavelength signals may be transferred onto different detectors, particularly comprised by a respective detector module, which generate separate detector signal.

The first detector module and the second detector module may be configured for detecting a different wavelength range, particularly by
arranging a first optical filter in a manner that the reflected radiation is propagating through the optical filter onto the at least one first detector module; and
arranging a second optical filter in a manner that the transmitted radiation is propagating through the optical filter onto the at least one second detector module;
   wherein the first optical filter and the second optical filter may be different from each other, particularly. Thereby the first detector module and the second detector module may generate different spectrums.

The first detector module and the second detector module may be configured for an optimized chemical classification of at least two different samples, particularly by
arranging a first optical filter in a manner that the reflected radiation is propagating through the optical filter onto the at least one first detector module; and
arranging a second optical filter in a manner that the transmitted radiation is propagating through the optical filter onto the at least one second detector module;
   wherein the first optical filter and the second optical filter may be different and selected for detecting the at least two different samples.

At least one of:
the first optical filter; or
the second optical filter;
   may be at least one of:
at least one optical filter;
at least one polarization filter;
at least one bandpass filter;
at least one liquid crystal filter, in particular a liquid crystal tunable filter;
at least one short-pass filter;
at least one long-pass filter;
at least one notch filter;
at least one interference filter;
at least one transmission grating;
at least one nonlinear optical element, in particular at least one birefringent optical element, or at least one tunable Fabry-Pérot interferometer;
at least one tunable Michelson interferometer;
at least one linear variable filter;
at least one bandpass filter;
at least one quantum dot; or
at least one well filter.

The at least one light source and the first detector module may be arranged on a first side of the sample holder such that the radiation emitted by the at least one light source may be detectable by the at least one first detector module after reflecting on the sample in the sample holder; and the at least one second detector module may be arranged on a second side of the sample holder that may be opposite to the first side such that the radiation emitted by the at least one light source may be detectable by the at least one second detector module after transmitting through the sample in the sample holder.

The at least one light source and the first detector module may be arranged on a first side of the sample holder such that the radiation emitted by the at least one light source may be detectable by the at least one first detector module after reflecting on the sample in the sample holder; and the at least one second detector module may be further arranged on the first side of the sample holder and at least one reflector may be arranged on a second side of the sample holder that may be opposite to the first side such that the radiation emitted by the at least one light source may be detectable by the at least one second detector module after transmitting through the sample in the sample holder, reflecting on the at least one reflector and transmitting through the sample in the sample holder again.

The reflector may be at least one of:
a reflective coating, in particular a mirror;
a beam-splitting device;
an interference layer; or
a dichroic filter.

A first radiation source and the at least one detector module may be arranged on a first side of the sample holder such that the radiation emitted by the first radiation source may be detectable by the at least one detector module after reflecting on the sample in the sample holder; and a second radiation source may be arranged on a second side of the sample holder that may be opposite to the first side such that the radiation emitted by the second radiation source may be detectable by the at least one detector module after transmitting through the sample in the sample holder. The radiation emitted by the first radiation source may have at least one different wavelength than the radiation emitted by the first radiation source. Alternatively or in addition, the radiation emitted by the first radiation source may be emitted during a first time interval and the radiation emitted by the second radiation source may be emitted during a second time interval, wherein the first time interval may be different then the first time interval. Thereby, the detected radiation emitted by the first radiation source and the second radiation source may be distinguishable.

According to a further aspect of the present invention, a method for a classification of a sample is disclosed. The method is comprising the following steps, which may be performed in the given order. A different order, however, may also be feasible. Further, two or more of the method steps may be performed simultaneously. Thereby the method steps may at least partly overlap in time. Further, the method steps may be performed once or repeatedly. Thus, one or more or even all of the method steps may be performed once or repeatedly. The method may comprise additional method steps, which are not listed herein.

The method for a classification of a sample is comprising the following steps:
(a) providing a spectrometer device as explained elsewhere herein;
(b) placing a sample in a sample holder;
(c) classifying the sample by considering the first detector module signal and the second detector module signal, wherein a physical property of the sample is determined as a physical classification of the sample and a chemical property of the sample is determined as a chemical classification of the sample.

In step (c)
the evaluated physical classification of the sample and
the evaluated chemical classification of the sample,
   are combined for ruling out ambiguities in the physical classification by considering the chemical classification; or vice versa.

For further details concerning the method for a classification of a sample, a reference may be made to any aspect or definition according to the present invention as disclosed elsewhere herein.

According to a further aspect of the present invention, a computer program is disclosed. The computer program is comprising instructions which, when the program is executed by at least one evaluation device comprised by a spectrometer device as explained elsewhere herein, cause the at least one evaluation device to perform step (c) of the method for a classification of a sample as explained elsewhere herein.

The term “computer program” as used herein is a broad term and is to be given its ordinary and customary meaning to a person of ordinary skill in the art and is not to be limited to a special or customized meaning. The term specifically may refer, without limitation, to at least one executable instruction for at least one programmable apparatus, specifically a computer, preferably a sequence of executable instructions, for processing and/or solving of at least one function and/or at least one task and/or at least one problem by using at least one programmable apparatus, specifically a computer, preferably for performing some or all steps of any one of the methods according to any aspect or embodiment as described within the present invention. Typically, instructions are combined to a computer program code and/or provided in a programming language. A computer program is typically processed by using a processing device comprised by the at least one computer. For this purpose, the computer program may be running on the computer. The computer program code may be provided on a data storage medium or a separate device such as an optical storage medium, e.g. on a compact disc, directly on a computer or data processing device, or via a network, such as via an in-house network or via internet.

For further details concerning computer program, a reference may be made to any aspect or definition according to the present invention as disclosed elsewhere herein.

According to a further aspect of the present invention, a non-transient computer-readable storage medium is disclosed. The non-transient computer-readable storage medium is comprising instructions which, when the program is executed by at least one evaluation device comprised by a spectrometer device as explained elsewhere herein, cause the at least one evaluation device to perform step (c) of the method for a classification of a sample as explained elsewhere herein.

Specifically, the computer program may be stored on a computer-readable data carrier and/or on a computer-readable storage medium. As used herein, the terms “computer-readable data carrier” and “computer-readable storage medium” specifically may refer to non-transitory data storage unit, such as a hardware storage medium having stored thereon computer-executable instructions. The computer-readable data carrier or storage medium specifically may be or may comprise a storage medium such as a random-access memory (RAM) and/or a read-only memory (ROM). For example, the computer program may be stored using at least one database such as of a server or a cloud server.

For further details concerning the non-transient computer-readable storage medium, a reference may be made to any aspect or definition according to the present invention as disclosed elsewhere herein.

The above-described spectrometer device for a classification of a sample, the method for a classification of a sample, the computer program and the non-transient computer-readable storage medium may have considerable advantages over the prior art. Thus provide a compact spectrometer device that may be capable of a reliable, easy, versatile and fast classification of a sample. The combination of the physical classification and the chemical classification may further provide the opportunity of a fast presorting of e.g. plastics. Alternatively or in addition, a detection and/or a sorting of metals, glass and/or smallest parts of an arbitrary material may be possible due to the determination of a reflection and/or a transmission property. Thereby, the combination of the physical classification and the chemical classification may provide the opportunity to specifically setup up components of the spectrometer device, such as the at least one radiation source and/or the first detector module and/or the second detector module in a manner that this combination may be considered. As a result, the spectrometer device may be compact particularly cost efficient and robust, as less complex components may be required. Thus for the overall system a simplification of the required optical components may be possible. Exemplarily, the number of detectors may be reduced, particularly as no detector arrays may be necessary. Alternatively or in addition, it may be possible to implement simpler filters, particularly no prism and/or gratings. Alternatively or in addition, it may be possible to use simpler light sources and/or simplify a control of the spectrometer and/or a readout of the spectrometer and/or an analysis of the measured data and/or reduce the device footprint.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In most cases, when referring to the respective feature or element, the expressions “at least one” or “one or more” will not be repeated, notwithstanding the fact that the respective feature or element may be present once or more than once.

As further used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the person skilled in the art will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Summarizing the above-mentioned findings, the following embodiments are preferred within the present invention:

### Embodiment 1

A spectrometer device for a classification of a sample comprising
at least one radiation source, wherein the at least one radiation source is configured for emitting radiation;
at least one sample holder, wherein the at least one sample holder is configured for holding a sample;
at least one detector module,
   wherein the at least one detector module is arranged in a manner to detect at least a portion of the emitted radiation that is reflected or transmitted by the sample such that a first detector module signal is generated;
   wherein the at least one detector module is further arranged in a manner to detect at least a portion of the emitted radiation that is transmitted or reflected through the sample such that a second detector module signal is generated;
at least one evaluation device, wherein the at least one evaluation device is configured for performing a physical classification of the sample and a chemical classification of the sample by considering the first detector module signal and the second detector module signal.

### Embodiment 2

The spectrometer device according to the preceding Embodiment, wherein the physical classification is based on an integrated detector module signal provided by considering at least one of:
the first detector module signal; or
the second detector module signal,
   wherein the integrated detector module signal is configured for determining an intensity of radiation incident on the at least one detector module.

### Embodiment 3

The spectrometer device according to any one of the preceding Embodiments, wherein the first detector module signal and the second detector module signal are considered for performing the physical classification by at least one of:
determining a ratio between the first detector module signal and the second detector module signal, or vice versa; or
determining a difference between the first detector module signal and the second detector module signal, or vice versa.

### Embodiment 4

The spectrometer device according to any one of the preceding Embodiments, wherein the sample is classified by the physical classification by at least one of:
a reflection value related to the sample; or
a transmission value related to the sample.

### Embodiment 5

The spectrometer device according to any one of the preceding Embodiments, wherein the chemical classification is based on at least one wavelength resolved detector module signal provided by considering at least one of:
the first detector module signal; or
the second detector module signal,
   wherein the wavelength resolved detector module signal is configured for determining a spectrum of the sample.

### Embodiment 6

The spectrometer device according to any one of the preceding Embodiments, wherein the at least one detector module comprises at least a first detector generating a first detector signal and a second detector generating a second detector signal, wherein the first detector and the second detector detect at least one intensity of at least one different wavelength.

### Embodiment 7

The spectrometer device according to any one of the preceding Embodiments, wherein the first detector signal and the second detector signal of the first detector module are considered for performing the chemical classification of the sample by at least one of:
determining at least a portion of a spectrum;
considering at least one chemometric technique.

### Embodiment 8

The spectrometer device according to any one of the preceding Embodiments, wherein the at least one evaluation device is configured to determine a chemical property of the sample for performing the chemical classification of the sample, particularly wherein the chemical property of the sample is a chemical composition of the sample.

### Embodiment 9

The spectrometer device according to any one of the preceding Embodiments, wherein the evaluation device is configured to combine
an evaluated physical classification of the sample and
an evaluated chemical classification of the sample,
   particularly for ruling out ambiguities in the evaluated physical classification by considering the evaluated chemical classification; or vice versa.

### Embodiment 10

The spectrometer device according to any one of the preceding Embodiments, wherein at least one of:
the first detector module signal; or
the second detector module signal;
   is configured for detecting only at least one selected features in a spectrum provided by the sample in the chemical classification that are required for ruling out ambiguities in the evaluated physical classification.

### Embodiment 11

The spectrometer device according to any one of the preceding Embodiments, wherein the at least one radiation source is configured for emitting only radiation required for detecting at least one selected feature in a spectrum provided by the sample in the chemical classification that is used for ruling out ambiguities in the evaluated physical classification.

### Embodiment 12

The spectrometer device according to any one of the preceding Embodiments, wherein the at least one radiation source is at least one of
a thermal radiator, particularly selected from at least one of:
   a blackbody;
   an incandescent lamp, or
   a MEMS-based emitters; or
a semiconductor-based radiation source, particularly selected from at least one of:
   a light emitting diode (LED);
   a laser, in particular selected from at least one of:
      a laser diode;
      a VCSEL;
      a quantum-well/dots;
      a plasma radiation sources, such as a low/high pressures source, or a Xenon source;
      a gas laser; or
      a solid state laser.

### Embodiment 13

The spectrometer device according to any one of the preceding Embodiments, wherein the at least one radiation source is emitting infrared radiation having a wavelength of 780 nm to 15 μm, preferably of 1 μm to 5 μm, more preferred of 1 μm to 3 μm, in particular of 2 μm to 3 μm.

### Embodiment 14

The spectrometer device according to any one of the preceding Embodiments, wherein the at least one detector module comprises a first detector module and a second detector module, wherein the first detector module is configured for generating the first detector module signal, wherein the second detector module is configured for generating the second detector module signal.

### Embodiment 15

The spectrometer device according to any one of the preceding Embodiments, wherein the at least one detector module, particularly the first detector module and/or the second detector module, comprises at least one detector having a photoconductive material selected from at least one of lead sulfide (PbS), lead selenide (PbSe), germanium (Ge), indium gallium arsenide (InGaAs, including but not limited to ext. InGaAs), indium antimonide (InSb), or mercury cadmium telluride (HgCdTe or MCT).

### Embodiment 16

The spectrometer device according to any one of the preceding Embodiments, wherein the first detector module and the second detector module are configured for detecting an identical wavelength range, particularly by
arranging a first optical filter in a manner that the reflected radiation is propagating through the optical filter onto the at least one first detector module; and
arranging a second optical filter in a manner that the transmitted radiation is propagating through the optical filter onto the at least one second detector module;
   wherein the first optical filter and the second optical filter are identical.

### Embodiment 17

The spectrometer device according to any one of the preceding Embodiments, wherein the first detector module and the second detector module are configured for detecting a different wavelength range, particularly by
arranging a first optical filter in a manner that the reflected radiation is propagating through the optical filter onto the at least one first detector module; and
arranging a second optical filter in a manner that the transmitted radiation is propagating through the optical filter onto the at least one second detector module;
   wherein the first optical filter and the second optical filter are different.

### Embodiment 18

The spectrometer device according to any one of the preceding Embodiments, wherein the first detector module and the second detector module are configured for an optimized chemical classification of at least two different samples, particularly by
arranging a first optical filter in a manner that the reflected radiation is propagating through the optical filter onto the at least one first detector module; and
arranging a second optical filter in a manner that the transmitted radiation is propagating through the optical filter onto the at least one second detector module;
   wherein the first optical filter and the second optical filter are different from each other, particularly and selected for detecting the at least two different samples.

### Embodiment 19

The spectrometer device according to any one of the preceding Embodiments, wherein at least one of:
the first optical filter; or
the second optical filter;
   are at least one of:
at least one optical filter;
at least one polarization filter;
at least one bandpass filter;
at least one liquid crystal filter, in particular a liquid crystal tunable filter;
at least one short-pass filter;
at least one long-pass filter;
at least one notch filter;
at least one interference filter;
at least one transmission grating;
at least one nonlinear optical element, in particular at least one birefringent optical element, or at least one tunable Fabry-Pérot interferometer;
at least one tunable Michelson interferometer;
at least one linear variable filter;
at least one bandpass filter;
at least one quantum dot; or
at least one well filter.

### Embodiment 20

the Spectrometer Device According to Any One of the Preceding Embodiments, wherein
the at least one light source and the first detector module are arranged on a first side of the sample holder such that the radiation emitted by the at least one light source is detectable by the at least one first detector module after reflecting on the sample in the sample holder; and wherein
the at least one second detector module is arranged on a second side of the sample holder that is opposite to the first side such that the radiation emitted by the at least one light source is detectable by the at least one second detector module after transmitting through the sample in the sample holder.

### Embodiment 21

The spectrometer device according to any one of the preceding Embodiments, wherein
the at least one light source and the first detector module are arranged on a first side of the sample holder such that the radiation emitted by the at least one light source is detectable by the at least one first detector module after reflecting on the sample in the sample holder; and wherein
the at least one second detector module is further arranged on the first side of the sample holder and at least one reflector is arranged on a second side of the sample holder that is opposite to the first side such that the radiation emitted by the at least one light source is detectable by the at least one second detector module after transmitting through the sample in the sample holder, reflecting on the at least one reflector and transmitting through the sample in the sample holder again.

### Embodiment 22

The spectrometer device according to any one of the preceding Embodiments, wherein the reflector is at least one of:
a reflective coating, in particular a mirror;
a beam-splitting device;
an interference layer; or
a dichroic filter.

### Embodiment 23

The spectrometer device according to any one of the preceding Embodiments, wherein
a first radiation source and the at least one detector module are arranged on a first side of the sample holder such that the radiation emitted by the first radiation source is detectable by the at least one detector module after reflecting on the sample in the sample holder; and wherein
a second radiation source is arranged on a second side of the sample holder that is opposite to the first side such that the radiation emitted by the second radiation source is detectable by the at least one detector module after transmitting through the sample in the sample holder.

### Embodiment 24

The spectrometer device according to any one of the preceding Embodiments, wherein the sample comprises a sample material selected from at least one of:
a polymer material;
a pharmaceutical material;
an organic material, particularly comprised by food, beverage, or a skin, specifically a skin of a human.

### Embodiment 25

A method for a classification of a sample, the method comprising the following steps:
(a) providing a spectrometer device according to any one of the preceding device Embodiments;
(b) placing a sample in a sample holder;
(c) classifying the sample by considering the first detector module signal and the second detector module signal, wherein a physical property of the sample is determined as a physical classification of the sample and a chemical property of the sample is determined as a chemical classification of the sample.

### Embodiment 26

The method according to the preceding Embodiment, wherein in step (c)
the evaluated physical classification of the sample and
the evaluated chemical classification of the sample,
   are combined, particularly for ruling out ambiguities in the physical classification by considering the chemical classification; or vice versa.

### Embodiment 27

A computer program comprising instructions which, when the program is executed by at least one evaluation device comprised by a spectrometer device according to any one of the preceding device Embodiments, cause the at least one evaluation device to perform step (c) of the method for a classification of a sample according to any one of the preceding method Embodiments.

### Embodiment 28

A non-transient computer-readable storage medium comprising instructions which, when the program is executed by at least one evaluation device comprised by a spectrometer device according to any one of the preceding device Embodiments, cause the at least one evaluation device to perform step (c) of the method for a classification of a sample according to any one of the preceding method Embodiments.

### BRIEF DESCRIPTION OF THE FIGURES

Further optional features and embodiments will be disclosed in more detail in the subsequent description of embodiments, preferably in conjunction with the dependent claims. Therein, the respective optional features may be implemented in an isolated fashion as well as in any arbitrary feasible combination, as the person skilled in the art will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 illustrates an exemplary spectrometer device for a classification of a sample according to the present invention;

FIG. 2 illustrates an alternative exemplary spectrometer device for a classification of a sample according to the present invention;

FIG. 3 illustrates a further alternative exemplary spectrometer device for a classification of a sample according to the present invention; and

FIG. 4 illustrates an exemplary method for a classification of a sample according to the present invention.

### EXEMPLARY EMBODIMENTS

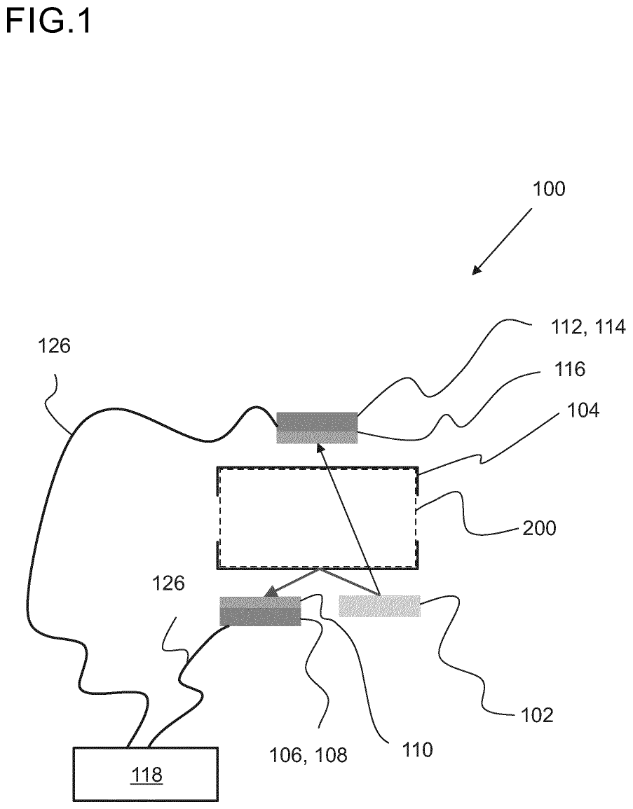

FIG. 1 illustrates an exemplary spectrometer device 100 for a classification of a sample 200. The classification of the sample 200 may particularly comprise a chemical classification of the sample 200 for determining a material composition of the sample 200.

The exemplary spectrometer device 100 comprise at least one radiation source 102 that is configured for emitting radiation (indicated by the arrows). The at least one radiation source 102 may be emitting electromagnetic radiation, specifically infrared radiation having a wavelength of 780 nm to 15 μm, preferably of 1 μm to 5 μm, more preferred of 1 μm to 3 μm, in particular of 2 μm to 3 μm.

The at least one radiation source 102 may be a thermal radiator, particularly a blackbody, and/or an incandescent lamp, and/or a MEMS-based emitters. Alternatively or in addition, the at least one radiation source 102 may be a semiconductor-based radiation source 102, particularly a light emitting diode (LED), and/or a laser, in particular a laser diode, and/or a VCSEL, and/or a quantum-well/dots, and/or a plasma radiation source 102, such as a low/high pressures source, or a Xenon source, and/or a gas laser, and/or a solid state laser.

The exemplary spectrometer device 100 further comprises at least one sample holder 104, wherein the at least one sample holder 104 is configured for holding a sample 200. The sample 200 may comprises a sample 200 material such as a polymer material. Alternatively or in addition, the sample 200 may comprise a sample material selected from a pharmaceutical material and/or an organic material, particularly comprised by food, beverage, or a skin, specifically a skin of a human.

The exemplary spectrometer device 100 further comprises at least one detector module 106, 112 comprising a first detector module 106, wherein the first detector module 106 is arranged in a manner to detect at least a portion of the emitted radiation that is reflected by the sample 200 such that a first detector module 106 signal is generated.

The first detector module 106 may comprises at least one detector 108 having a photoconductive material selected from at least one of lead sulfide (PbS), lead selenide (PbSe), germanium (Ge), indium gallium arsenide (InGaAs, including but not limited to ext. InGaAs), indium antimonide (InSb), or mercury cadmium telluride (HgCdTe or MCT).

A first optical filter 110 may be arranged in a manner that the reflected radiation is propagating through the first optical filter 110 onto the at least one first detector module 106, particularly the at least one detector 108. The first optical filter 110 may generate a spectrum of the sample 200.

The at least one detector module 106, 112 of the exemplary spectrometer device 100 further comprises at least one second detector module 112, wherein the at least one second detector module 112 is arranged in a manner to detect at least a portion of the emitted radiation that is transmitted through the sample 200 such that a second detector module 112 signal is generated.

The second detector module 112 may comprise at least one detector 114 having a photoconductive material selected from at least one of lead sulfide (PbS), lead selenide (PbSe), germanium (Ge), indium gallium arsenide (InGaAs, including but not limited to ext. InGaAs), indium antimonide (InSb), or mercury cadmium telluride (HgCdTe or MCT).

A second optical filter 116 may be arranged in a manner that the reflected radiation is propagating through the optical filter 116 onto the at least one second detector module 112, particularly the at least one detector 114. The second optical filter 116 may generate a spectrum of the sample 200.

The first optical filter, and/or the second optical filter 116 may be at least one polarization filter, and/or at least one bandpass filter, and/or at least one liquid crystal filter, in particular a liquid crystal tunable filter, and/or at least one short-pass filter, and/or at least one long-pass filter, and/or at least one notch filter, and/or at least one interference filter, and/or at least one transmission grating, and/or at least one nonlinear optical element, in particular at least one birefringent optical element, or at least one tunable Fabry-Perot interferometer, and/or at least one tunable Michelson interferometer, and/or at least one linear variable filter, and/or at least one bandpass filter, and/or at least one quantum dot, and/or at least one well filter.

The exemplary spectrometer device 100 further comprises at least one evaluation device 118, wherein the at least one evaluation device 118 is configured for performing a physical classification of the sample 200, particularly in addition, to the chemical classification of the sample 200 by considering the first detector module 106 signal and the second detector module 112 signal. The evaluation device 118 may be connect to the first detector module 106 and/or the second detector module 112 via a signal connection 126, specifically a wire, for transmitting at least one electronic signal and/or at least one optical signal.

The physical classification may be based on an integrated detector module signal provided by considering the respective detector module signal, wherein the wavelength resolved detector module signal may be configured for determining a spectrum of the sample. The first detector module 106 signal and the second detector module 112 signal may considered for performing the physical classification by at least one of:
determining a ratio between the first detector module 106 signal and the second detector module 112 signal, or vice versa, or
determining a difference between the first detector module 106 signal and the second detector module 112 signal, or vice versa.
   The sample 200 may classified by the physical classification by at least one of:
a reflection value related to the sample 200, or
a transmission and/or a transparency value related to the sample 200.

The chemical classification may be based on at least one wavelength resolved detector module signal provided by considering the respective detector module signal, particularly configured for determining a spectrum of the sample 200.

The at least one detector module 106, 112, specifically the first detector module 106 and/or the second detector module 112 may comprise at least a first detector generating a first detector signal and a second detector generating a second detector signal, wherein the first detector and the second detector may detect at least one intensity of at least one different wavelength. The first optical filter may be arranged in a manner to guide different wavelength ranges to different detectors comprised by the first detector module 106.

The first detector signal and the second detector signal of the first detector module 106 may considered for performing the chemical classification of the sample 200 by at least one of:
determining at least a portion of a spectrum,
considering at least one chemometric technique.

The evaluation device 118 is configured to combine
an evaluated physical classification of the sample 200 and
an evaluated chemical classification of the sample 200,
   for ruling out ambiguities in the evaluated physical classification by considering the evaluated chemical classification, or vice versa.

The first detector module 106 signal, and/or the second detector module 112 signal may be configured for detecting only at least one selected features in a spectrum provided by the sample 200 in the chemical classification that may be required for ruling out ambiguities in the evaluated physical classification.

The at one radiation source 102 may configured for emitting only radiation required for detecting at least one selected features in a spectrum provided by the sample 200 in the chemical classification that may be used for ruling out ambiguities in the evaluated physical classification.

The first detector module 106 and the second detector module 112 may be configured for detecting an identical wavelength range, particularly by
arranging the first optical filter in a manner that the reflected radiation is propagating through the optical filter onto the at least one first detector module 106, and
arranging the second optical filter 116 in a manner that the transmitted radiation is propagating through the optical filter onto the at least one second detector module 112,
   wherein the first optical filter and the second optical filter 116 may be identical.

The first detector module 106 and the second detector module 112 may be configured for detecting a different wavelength range, particularly by
arranging the first optical filter in a manner that the reflected radiation may be propagating through the optical filter onto the at least one first detector module 106, and
arranging the second optical filter 116 in a manner that the transmitted radiation may be propagating through the optical filter onto the at least one second detector module 112,
   wherein the first optical filter and the second optical filter 116 may be different.

The first detector module 106 and the second detector module 112 may be configured for an optimized chemical classification of at least two different samples 200, particularly by
arranging a first optical filter in a manner that the reflected radiation may be propagating through the optical filter onto the at least one first detector module 106, and
arranging a second optical filter 116 in a manner that the transmitted radiation may be propagating through the optical filter onto the at least one second detector module 112,
   wherein the first optical filter and the second optical filter 116 may be different and selected for detecting the at least two different samples 200.

In the exemplary embodiment of FIG. 1, the at least one light source and the first detector module 106 are arranged on a first side of the sample 200 holder 104 such that the radiation emitted by the at least one light source may be detectable by the at least one first detector module 106 after reflecting on the sample 200 in the sample 200 holder 104. The at least one second detector module 112 may be arranged on a second side of the sample 200 holder 104 that may be opposite to the first side such that the radiation emitted by the at least one light source may be detectable by the at least one second detector module 112 after transmitting through the sample 200 in the sample 200 holder 104.

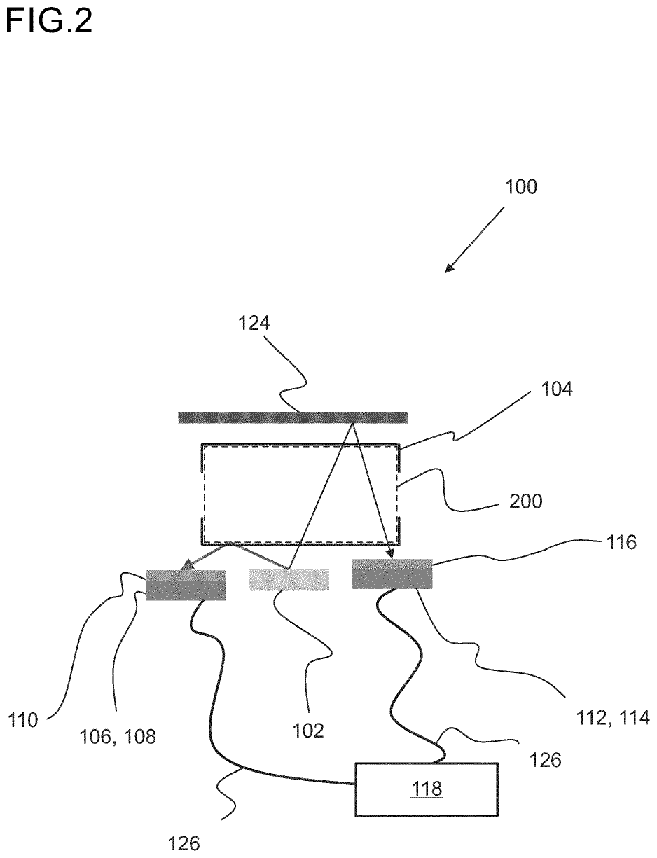

In the exemplary embodiment of FIG. 2, the at least one light source and the first detector module 106 may be arranged on a first side of the sample 200 holder 104 such that the radiation emitted by the at least one light source may be detectable by the at least one first detector module 106 after reflecting on the sample 200 in the sample 200 holder 104. The at least one second detector module 112 may be further arranged on the first side of the sample 200 holder 104 and at least one reflector 124 may be arranged on a second side of the sample 200 holder 104 that may be opposite to the first side such that the radiation emitted by the at least one light source may be detectable by the at least one second detector module 112 after transmitting through the sample 200 in the sample 200 holder 104, reflecting on the at least one reflector 124 and transmitting through the sample 200 in the sample 200 holder 104 again.

The reflector 124 may be a reflective coating, in particular a mirror, and/or a beam-splitting device, and/or an interference layer, and/or a dichroic filter.

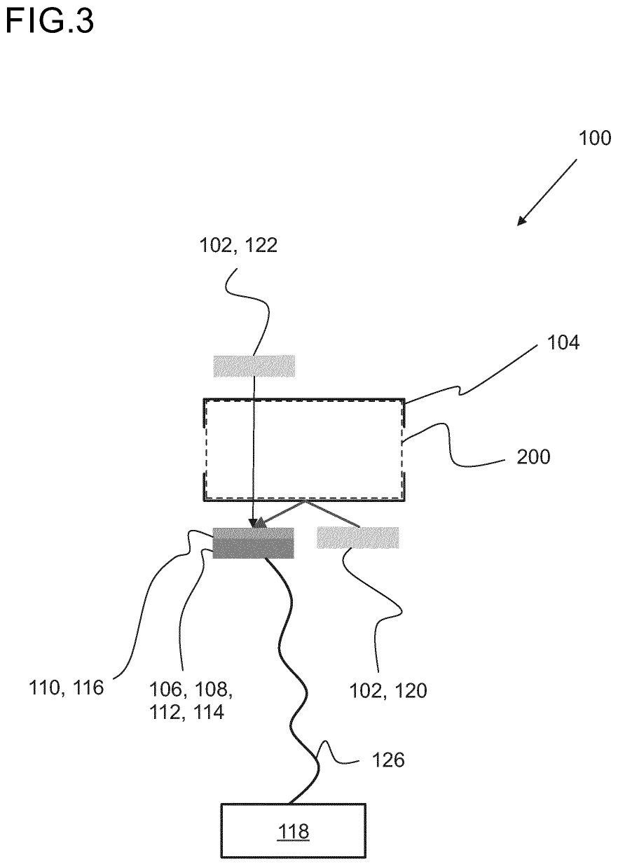

In the exemplary embodiment of FIG. 3, a first radiation source 120 and the at least one detector module 106, 112 are arranged on a first side of the sample 200 holder 104 such that the radiation emitted by the first radiation source 120 may be detectable by the at least one detector module 106, 112 after reflecting on the sample 200 in the sample 200 holder 104. A second radiation source 122 may be arranged on a second side of the sample 200 holder 104 that may be opposite to the first side such that the radiation emitted by the second radiation source 122 is detectable by the at least one detector module 106, 112 after transmitting through the sample 200 in the sample 200 holder 104.

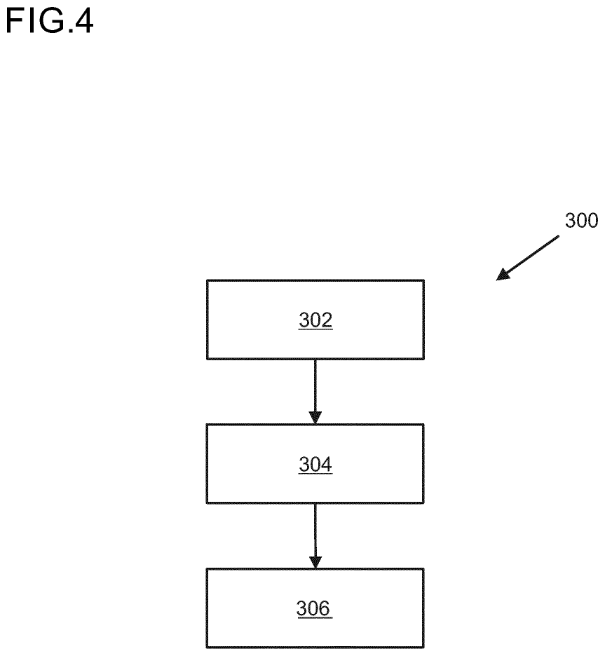

In FIG. 4, a method for a classification of a sample 300 is displayed. The method 300 is comprising the following steps:
(a) providing a spectrometer device 302 according to any one of the preceding device claims,
(b) placing a sample 304 in a sample 200 holder 104,
(c) classifying the sample 306 by considering the first detector module 106 signal, and particularly further the second detector module 112 signal, wherein a physical property of the sample 200 is determined as a physical classification of the sample 200 and a chemical property of the sample 200 is determined as a chemical classification of the sample 200.

In step (c) 306
the evaluated physical classification of the sample 200 and
the evaluated chemical classification of the sample 200,
   are combined for ruling out ambiguities in the physical classification by considering the chemical classification, or vice versa.

### LIST OF REFERENCE NUMBERS

100 spectrometer device
102 radiation source
104 sample holder
106 first detector module
108 detector
110 first optical filter
112 second detector module
114 detector
116 second optical filter
118 evaluation device
120 first radiation source
122 second radiation source
124 reflector
126 signal connection
200 sample
300 method for a classification of a sample
302 step (a): providing a spectrometer device
304 step (b): placing a sample
306 step (c): classifying the sample

1. A spectrometer device for a classification of a sample comprising
at least one radiation source, wherein the at least one radiation source is configured for emitting radiation;
at least one sample holder, wherein the at least one sample holder is configured for holding a sample;
at least one detector module,
wherein the at least one detector module is arranged in a manner to detect at least a portion of the emitted radiation that is reflected by the sample such that a first detector module signal is generated; and
wherein the at least one detector module is further arranged in a manner to detect at least a portion of the emitted radiation that is transmitted through the sample such that a second detector module signal is generated; and
at least one evaluation device, wherein the at least one evaluation device is configured for performing a physical classification of the sample and a chemical classification of the sample by considering the first detector module signal and the second detector module signal, wherein the evaluation device is configured to combine
an evaluated physical classification of the sample and
an evaluated chemical classification of the sample
for ruling out ambiguities in the evaluated physical classification by considering the evaluated chemical classification; or vice versa.

2. The spectrometer device according to claim 1, wherein the physical classification is based on an integrated detector module signal provided by considering at least one of:
the first detector module signal; or
the second detector module signal,
wherein the integrated detector module signal is configured for determining an intensity of radiation incident on the at least one detector module.

3. The spectrometer device according claim 1, wherein the sample is classified by the physical classification by at least one of:
a reflection value related to the sample; or
a transmission value related to the sample.

4. The spectrometer device according to claim 1, wherein the chemical classification is based on at least one wavelength resolved detector module signal provided by considering at least one of:
the first detector module signal; or
the second detector module signal,
wherein the wavelength resolved detector module signal is configured for determining a spectrum of the sample.

5. The spectrometer device according to claim 1, wherein the at least one detector module comprises at least a first detector generating a first detector signal and a second detector generating a second detector signal, and wherein the first detector and the second detector detect at least one intensity of at least one different wavelength.

6. The spectrometer device according to claim 1, wherein the at least one evaluation device is configured to determine a chemical property of the sample for performing the chemical classification of the sample, wherein the chemical property of the sample is a chemical composition of the sample.

7. The spectrometer device according to claim 6, wherein at least one of:
the first detector module signal; or
the second detector module signal;
is configured for detecting only at least one selected feature in a spectrum provided by the sample in the chemical classification that are required for ruling out ambiguities in the evaluated physical classification.

8. The spectrometer device according to claim 6, wherein the at least one radiation source is configured for emitting only radiation required for detecting at least one selected feature in a spectrum provided by the sample in the chemical classification that is used for ruling out ambiguities in the evaluated physical classification.

9. The spectrometer device according to claim 1, wherein the at least one detector module comprises a first detector module and a second detector module, wherein the first detector module is generating the first detector module signal, wherein the second detector module is generating the second detector module signal, and wherein the first detector module and the second detector module are configured for detecting a different wavelength range.

10. The spectrometer device according to claim 9, wherein a first optical filter is arranged in a manner that the reflected radiation is propagating through the optical filter onto the at least one first detector module; wherein a second optical filter is arranged in a manner that the transmitted radiation is propagating through the optical filter onto the at least one second detector module; and wherein the first optical filter and the second optical filter are different from each other.

11. A method for a classification of a sample, the method comprising the following steps:
(a) providing a spectrometer device according to claim 1;
(b) placing a sample in a sample holder;
(c) classifying the sample by considering the first detector module signal and the second detector module signal, wherein a physical property of the sample is determined as a physical classification of the sample and a chemical property of the sample is determined as a chemical classification of the sample, and
wherein in step (c)
the evaluated physical classification of the sample, and
the evaluated chemical classification of the sample
are combined for ruling out ambiguities in the physical classification by considering the chemical classification; or vice versa.

12. A computer program comprising instructions which, when the program is executed by at least one evaluation device comprised by a spectrometer device, cause the at least one evaluation device to perform step (c) of the method for a classification of a sample according to claim 11.

13. A non-transient computer-readable storage medium comprising instructions which, when the program is executed by at least one evaluation device comprised by a spectrometer device, cause the at least one evaluation device to perform step (c) of the method for a classification of a sample according to claim 11.
